(19) United States
(12) Patent Application Publication
(10) Pub. No.: US 2026/0216688 A1
(43) Pub. Date: Jul. 30, 2026

(54) A Method of Preparing Carbon Particles

(71) Applicant: AGENCY FOR SCIENCE, TECHNOLOGY AND RESEARCH, Singapore (SG)

(72) Inventors: Xu Li, Singapore (SG); Ming Yan Tan, Singapore (SG); Mao Lu, Singapore (SG)

(21) Appl. No.: 19/146,260

(22) PCT Filed: Jan. 9, 2024
(86) PCT No.: PCT/SG2024/050015

§ 371 Date: Jul. 8, 2025

(30) Foreign Application Priority Data
Jan. 9, 2023 (SG) 10202300071W

(51) Int. Cl. B01J 20/02; B01J 20/20; B01J 20/28; B01J 20/30; B01J 20/32; B65D 81/26; C01B 32/05

(52) U.S. Cl. CPC B01J 20/0229; B01J 20/20; B01J 20/28019; B01J 20/3078; B01J 20/3204; B01J 20/3236; B01J 20/3293; B65D 81/266; C01B 32/05

(57) ABSTRACT

There is provided a method of preparing carbon particles and carbon particles prepared from the method. There is also provided a method of preparing a composite material. There is further provided a composite material and an article.

### REFERENCES TO RELATED APPLICATION

This application claims priority to Singapore application number 10202300071W filed with the Intellectual Property Office of Singapore on 9 Jan. 2023, the contents of which are hereby incorporated by reference.

### TECHNICAL FIELD

The present invention generally relates to a method of preparing carbon particles and carbon particles prepared from the method. The present invention further relates to a method of preparing a composite material. The present invention further relates to a composite material and an article.

### BACKGROUND ART

The presence of oxygen in packaging is a key factor limiting the quality of products packaged. Many foods, especially perishable foods such as fruits and vegetables, are very sensitive to oxygen. Food deterioration provoked by oxygen may cause oxidative rancidity of fats and oils, loss of vitamin C, discoloration and growth of microorganisms. One of the main purposes of food packaging is to protect the food packaged against oxygen, thus reducing quality changes and prolonging the shelf life of the food.

Many efforts have been made to provide packaging with good barrier property against permeation of oxygen. Conventionally, modified atmosphere and vacuum packaging are used to remove as much of oxygen as possible in the package prior sealing process. However, these technologies are unable to completely remove the oxygen from the packaging or completely retard the oxygen from penetrating into the packaging. The oxygen trapped in food items cannot be removed completely, even with vacuum packaging. The oxygen residues diffused from outside or trapped in food will cause spoilage of food items with short shelf life. Moreover, high cost and complicated operations are some issues related to modified atmosphere and vacuum packaging. Herein, the development of effective oxygen absorbent is highly desired to eliminate the oxygen residues (oxygen dissolved in the food or present in the headspace) in the packaging.

Oxygen absorbents or oxygen scavengers are becoming increasingly attractive in food packaging to protect products from the detrimental effects of oxygen exposure. Generally, oxygen scavengers are working based on the oxidation process. Conventional oxygen scavengers include iron powder, ascorbic acid, enzymes, unsaturated hydrocarbon, photosensitive polymers, etc. Organic, unsaturated hydrocarbon scavengers are relatively unstable and may lead to unpleasant odor as byproduct after the oxidation process. Among these oxygen scavengers, iron-based oxygen scavenger is the most well-known and market-available product due to its high scavenging efficiency, low cost and safety. The efficiency of iron-based oxygen scavenger is dependent on the absorption capacity (cm³ of O₂ absorbed/gram of iron) and absorption rate. It is postulated that a good dispersion (homogeneity) of iron particles on a carrier or support without agglomeration will enhance its absorption capacity. In addition, the size of stable iron particles (especially nanoparticles) and high surface areas of support are important factors to produce an oxygen scavenger with superior absorption capacity performance.

One conventional oxygen scavenger includes a mixture of fibrous material (pulp, acrylic fiber, cotton, wool and etc.), iron powder, water and electrolytic material. The oxygen scavenger may be manufactured via physical mixing, suspension and suction processes. However, the oxygen scavenging capacity of the oxygen scavenger is relatively low because of the large iron powder size of 50 to 250 μm.

Another conventional oxygen scavenger includes a nano-sized oxidizable metal component with a size in the range of 1 to 1000 nm, a carrier material, an electrolyte and a non-electrolytic acidifying component. The carrier material is a microporous material which may be derived from polymeric resin, zeolites, nano-clays, organic metal frameworks or aluminosilicates. The iron particles are prepared by NaBH₄ reduction method. The Fe^{o}-functionalized zeolite showed superior oxygen scavenging capacity at 130-255±40 cm³/g Fe in the zeolite after 48 hours of reaction. However, the oxygen scavenging performance of this oxygen scavenger is still unsatisfactory as the Fe⁰ used is prepared through NaBH₄ reduction, which would react with oxygen instantly. Therefore, it is difficult to handle this oxygen scavenger in a controlled manner in the presence of oxygen.

Another conventional oxygen scavenger includes microsized iron particles, sodium chloride and acidifying components such as aluminum chloride. To prepare such oxygen scavenger, all components are added into a mechanical mixer to achieve a uniform mixing of components. However, the scavenging performance of this scavenger was not investigated with experiments.

Another conventional oxygen scavenger includes carbon spheres impregnated with iron nano-particles. The iron nano-particles are uniformly embedded in the porous out layer of carbon support with good homogeneity and high stability under ambient conditions. However, the conversion yield of carbon particles from biomass is very low.

Accordingly, there is a need for a method of preparing an oxygen scavenger that ameliorates one or more disadvantages mentioned above.

### SUMMARY

In one aspect, there is provided a method of preparing carbon particles, comprising the steps of:
(a) treating a mixture comprising (i) an inorganic salt and (ii) a solution comprising a carbon source hydrothermally to form a solution of carbon particles; and
(b) collecting the carbon particles from the solution of the treating step (a).

In another aspect, there is provided carbon particles prepared from the method as described herein.

Advantageously, the carbon particles may have high absorption towards ions, particularly metal cations due to a presence of carboxylic acid moieties and hydroxyl moieties on a surface.

In another aspect, there is provided a method of preparing a composite material, comprising the steps of:
(a) forming a dispersion comprising carbon particles, a metal precursor, an amino additive and a solvent;
(b) drying the dispersion of the forming step (a) to form a dried powder; and
(c) heating the dried power of the drying step (b) in an atmosphere comprising an inert gas to obtain the composite material.

Advantageously, the amino additive may function as a binder to bind the carbon particles together during the heating step (c). The amino additive may also help to distribute the metal precursor more uniformly in the dispersion. Therefore, when the metal precursor is converted to metal particles during the heating step (c), the metal particles are distributed in the composite material more uniformly as well. Where the carbon particles are spherical, some metal particles may be embedded into a porous carbon out layer of the carbon particles and some metal particles may be allocated in an interstitial space between carbon particles (which may be regarded as carbon linkers between the carbon particles).

In another aspect, there is provided a composite material comprising a carbon support and a plurality of metal particles, wherein the metal particles are disposed within the carbon support.

Advantageously, the composite material may have high oxygen scavenging properties. This is because of a uniform distribution of Fe⁰ in the carbon support with high Fe⁰ content.

In another aspect, there is provided a composite material prepared by the method as described herein.

In another aspect, there is provided an article comprising the composite material as described herein.

### Definitions

The following words and terms used herein shall have the meaning indicated:

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

The term “about” as used herein typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### Detailed Disclosure of Embodiments

Exemplary, non-limiting embodiments of a method of preparing carbon particles will now be disclosed.

The method comprises the steps of:
(a) treating a mixture comprising (i) an inorganic salt and (ii) a solution comprising a carbon source hydrothermally to form a solution of carbon particles; and
(b) collecting the carbon particles from the solution of the treating step (a).

The method may comprise, before the treating step (a), the steps of:
(a1) acidifying a solution comprising a carbon source, a base and a solvent; and
(a2) mixing an inorganic salt and the solution of the acidifying step (a1) to form a mixture.

Advantageously, the acidifying step (a1) may form salts within the solution, which help to form surface pores on the carbon particles, when formed in the treating step (a). This may improve an absorption of the carbon particles towards ions, particularly metal cations.

Further advantageously, the mixing step (a2) may help to control the size of the carbon particles formed in treating step (a) as the inorganic salt may function as a nucleating agent when forming the carbon particles. The carbon particles may have a reduced size with a higher amount of the inorganic salt.

In the acidifying step (a1), non-limiting examples of the base include LiOH, NaOH, KOH and combinations thereof. The base may be NaOH. The base may help with dissolving the carbon source in the solution.

The solvent may be an aqueous medium. The solvent may comprise a combination of water and a water miscible solvent selected from the group consisting of ethanol, acetone, tetrahydrofuran, isopropyl alcohol and combinations thereof. The solvent may be water.

The solution may further comprise an additive. Non-limiting examples of the additive include monosaccharide, disaccharide, trisaccharide and combinations thereof. The additive may be glucose. Therefore, the acidifying step (a1) may further comprise a step (a3) of adding the additive to the solution after the acidifying step (a1). The adding step (a3) may be undertaken before or after the mixing step (a2).

The additive may have a weight percentage in the range of about 0 weight % to about 15 weight %, about 1 weight % to about 15 weight %, about 5 weight % to about 15 weight %, about 10 weight % to about 15 weight %, about 0 weight % to about 10 weight %, about 0 weight % to about 5 weight %, about 0 weight % to about 1 weight % or about 1 weight % to about 10 weight %, based on the total weight of the carbon source.

Advantageously, the additive may form carboxylic acid moieties and hydroxyl moieties onto the carbon particles during the treating step (a). This may improve absorption of the carbon particles towards ions, particularly metal cations.

The acidifying step (a1) may be undertaken by adding an acid into the solution. Non-limiting examples of the acid include HCl, H₂SO₄, HNO₃ and combinations thereof. The acid may be HCl.

The acidifying step (a1) may be undertaken until the solution has a pH value in the range of about 6 to about 10, about 7 to about 10, about 6 to about 9, about 7 to about 9 or about 7 to about 8.5. The acidifying step (a1) may be undertaken until the solution has a pH value of about 8. Advantageously, the method may have a higher yield of the carbon particles when the solution is acidified.

In the mixing step (a2), the inorganic salt may be provided at a weight percentage of about 0.1 weight % to about 5 weight %, about 0.2 weight % to about 5 weight %, about 0.3 weight % to about 5 weight %, about 1 weight % to about 5 weight %, about 0.2 weight % to about 1 weight % or about 0.2 weight % to about 0.3 weight %, based on the total weight of the carbon source.

Non-limiting examples of the inorganic salt include KH₂PO₄, NaCl, Na₂CO₃, Na₃PO₄, KCl, K₂SO₄, K₂CO₃, Na₂SO₄ and combinations thereof. The inorganic salt may be KH₂PO₄.

The mixing step (a2) may be undertaken for a duration in the range of about 1 hour to about 24 hours, about 1 hour to about 12 hours or about 12 hours to about 24 hours. The mixing step (a2) may be undertaken overnight. The mixing step (a2) may be alternatively or additionally undertaken for a duration that is sufficient to allow the inorganic salt to fully dissolve in the solution of the acidifying step (a1).

After the mixing step (a2), the carbon source may have a weight percentage in the range of about 1 weight % to about 20 weight %, about 2 weight % to about 20 weight %, about 8 weight % to about 20 weight %, about 1 weight % to about 8 weight %, about 1 weight % to about 2 weight % or about 2 weight % to about 8 weight % based on the total weight of the mixture. The carbon source may have a weight percentage of about 4 weight %, based on the total weight of the mixture.

In the treating step (a), the carbon source may be derived from a biomass material. The biomass material may be selected from the group consisting of lignin, saccharides, fatty acid, protein and combinations thereof. The biomass material may be lignin. The biomass material may be glucose.

The biomass material may have a carbon content of at least 30 weight %, at least 40 weight %, at least 50 weight % or at least 60 weight % based on the total weight of the biomass material. Where the biomass material is glucose, the carbon content of the biomass material is about 40 weight %.

Advantageously, the method may improve a yield of the carbon particles when a biomass material with a high carbon content is used.

The treating step (a) may be undertaken in a hydrothermal reactor or a high-pressure reactor.

In the hydrothermal reactor or the high-pressure reactor, the treating step (a) may be undertaken at a temperature in the range of about 150° C. to about 220° C., about 180° C. to about 220° C., about 190° C. to about 220° C., about 200° C. to about 220° C., about 210° C. to about 220° C., about 180° C. to about 210° C., about 180° C. to about 200° C. or about 180° C. to about 190° C. The treating step (a) may be undertaken at a temperature of about 210° C.

In the hydrothermal reactor or the high-pressure reactor, the treating step (a) may be undertaken at a pressure in the range of about 15 to about 35 bars (or about 1.5×10⁶ to about 3.5×10⁶ pascals).

Thus, the treating step (a) may comprise treating the mixture comprising (i) the inorganic salt and (ii) the solution comprising the carbon source at a hydrothermal condition, wherein the hydrothermal condition may comprise an elevated temperature in the range of about 150° C. to about 220° C. and/or an elevated pressure in the range of about 15 to about 35 bars (or about 1.5×10⁶ to about 3.5×10⁶ pascals).

The treating step (a) may be undertaken for a duration in the range of about 0.5 hour to about 12 hours, about 1 hour to about 12 hours, about 2.5 hours to about 12 hours about 4 hours to about 12 hours, about 0.5 hour to about 4 hours, about 0.5 hour to about 2.5 hours or about 0.5 hour to about 1 hour. The treating step (a) may be undertaken for a duration of about 2.5 hours.

The method may further comprise a step of adjusting a pH value of the solution of the treating step (a) after the treating step (a) but before the collecting step (b).

The adjusting step may be undertaken by adding an acid to the solution. Non-limiting examples of the acid include HCl, H₂SO₄, HNO₃ and combinations thereof. The acid may be HCl.

The adjusting step may be undertaken until the solution has a pH value in the range of about 0 to about 2, about 1 to about 2 or about 0 to about 1. The adjusting step may be undertaken until the solution has a pH value of about 1.

Advantageously, the adjusting step may improve the yield of the carbon particles by about 20%. This is because the solubility of carbon spheres in water will be lower after the adjusting step.

The collecting step (b) may comprise the steps of:
(b1) isolating the carbon particles from the solution of the treating step (a); and
(b2) drying the carbon particles.

The isolating step (b1) may be undertaken by centrifugation or filtration. The isolating step (b1) may be undertaken by centrifuging the solution of step (a) at about 9000 rpm for about 1 hour.

The collecting step (b) may further comprise a step of purifying the carbon particles after the isolating step (b1) but before the drying step (b2). The purifying step may be undertaken by stirring the carbon particles in deionized water for about 10 minutes, and subsequently removing the deionized water by centrifugation or filtration. The carbon particles may be gently or vigorously stirred in the purifying step. The purifying step may remove water soluble substances, including part of the carbon source that has not been converted to the carbon particles in the treating step (a). The purifying step may be repeated once, twice or a plurality of times.

The drying step (b2) may be undertaken at a temperature in the range of about 50° C. to about 100° C., about 50° C. to about 70° C., about 60° C. to about 70° C. or about 50° C. to about 60° C. The drying step (b2) may be undertaken at a temperature of about 60° C.

The drying step (b2) may be undertaken for a duration in the range of about 2 hours to about 3 days, about 1 day to about 3 days, about 2 days to about 3 days, about 2 hours to about 2 days, about 2 hours to about 1 day or about 1 day to about 2 days. The drying step (b2) may be undertaken for a duration of about 2 days.

The drying step (b2) may be undertaken in an oven.

Exemplary, non-limiting embodiments of carbon particles will now be disclosed.

The carbon particles may be prepared from the method as described herein.

Advantageously, the carbon particles may have high absorption towards ions, particularly metal cations due to a presence of carboxylic acid moieties and hydroxyl moieties on a surface.

The carbon particles may be spherical. Therefore, the carbon particles may also be referred to as carbon spheres.

The carbon particles may have a size in the range of about 20 nm to about 800 nm, about 100 nm to about 800 nm, about 200 nm to about 800 nm, about 300 nm to about 800 nm, about 500 nm to about 800 nm, about 100 nm to about 500 nm, about 100 nm to about 300 nm, about 100 nm to about 200 nm, about 200 nm to about 500 nm or about 200 nm to about 300 nm. Where the carbon particle is spherical, the size may refer to the diameter of the carbon particle, or where the carbon particle is an irregularly shaped particle, the size may refer to the equivalent diameter of the irregularly shaped carbon particle.

Exemplary, non-limiting embodiments of a method of preparing a composite material will now be disclosed.

The method comprises the steps of:
(a) forming a dispersion comprising carbon particles, a metal precursor, an amino additive, and a solvent;
(b) drying the dispersion of forming step (a) to form a dried powder; and
(c) heating the dried powder of the drying step (b) in an atmosphere comprising an inert gas to obtain the composite material.

The amino additive may comprise one or more amino groups. Non-limiting examples of the amino additive include glucosamine, galactosamine, diglucosamine, chitosan and combinations thereof. Advantageously, the amino additive may function as a binder to bind the carbon particles together during the heating step (c). The amino additive may also help to distribute the metal precursor more uniformly in the dispersion. Therefore, when the metal precursor is converted to metal particles during the heating step (c), the metal particles are distributed in the composite material more uniformly as well. Where the carbon particles are spherical, some metal particles may be embedded into a porous carbon out layer of the carbon particles and some metal particles may be allocated in an interstitial space between carbon particles (which may be regarded as carbon linkers between the carbon particles).

The composite material with the uniformly distributed metal particles may have at least about 20% higher oxygen scavenging capacity.

In the forming step (a), the carbon particles may be prepared by the method as described herein. Therefore, the method may comprise the steps of:
(a) treating a mixture comprising (i) an inorganic salt and (ii) a solution comprising a carbon source hydrothermally to form a solution of carbon particles;
(b) collecting the carbon particles from the solution of the treating step (a);
(c) forming a dispersion comprising the carbon particles of the collecting step (b), a metal precursor, amino additive and a solvent;
(d) drying the dispersion of the forming step (c) to form a dried powder; and
(e) heating the dried powder of the drying step (d) in an atmosphere comprising an inert gas to obtain the composite material.

In particular, the method may comprise the steps of:
(a1) acidifying a solution comprising a carbon source, a base and a solvent;
(a2) mixing an inorganic salt and the solution of the acidifying step (a1) to form a mixture;
(a) treating the mixture of the acidifying step (a2) hydrothermally to form a solution of carbon particles;
(b) collecting the carbon particles from the solution of the treating step (a);
(c) forming a dispersion comprising the carbon particles of the collecting step (b), a metal precursor, amino additive and a solvent;
(d) drying the dispersion of the forming step (c) to form a dried powder; and
(e) heating the dried powder of the drying step (d) in an atmosphere comprising an inert gas to obtain the composite material.

In the method, the composite material may be converted from a cluster of carbon particles (in which carbon particles are bound together through the amino additive) impregnated with the inorganic salt. Therefore, the composite material may comprise a skeleton derived from the carbon particles and linked by carbon converted from the amino additive. The amino additive may prevent the formation of large-sized metal particles during the final heating step. As described above, some metal particles may be distributed in the out layer of the carbon particles and some metal particles may be distributed in the carbon linkers between the carbon particles.

The carbon particles may have a weight percentage in the range of about 0.5 weight % to about 90 weight %, about 0.5 weight % to about 20 weight %, about 1 weight % to about 20 weight %, about 5 weight % to about 20 weight %, about 10 weight % to about 20 weight %, about 0.5 weight % to about 10 weight %, about 0.5 weight % to about 5 weight %, about 0.5 weight % to about 1 weight %, about 1 weight % to about 10 weight % or about 1 weight % to about 5 weight %, based on the total weight of the dispersion.

The metal precursor may be a salt of a metal. Non-limiting examples of the salt include nitrate, sulfate, halide and combinations and hydrates thereof. Non-limiting examples of the metal include iron, copper, zinc, ruthenium, osmium, cobalt, rhodium, iridium, manganese and combinations thereof. The metal precursor may be iron (III) nitrate or a hydrate thereof.

The metal precursor may have a weight percentage in the range of about 1 weight % to about 80 weight %, about 30 weight % to about 80 weight %, about 50 weight % to about 80 weight %, about 60 weight % to about 80 weight %, about 1 weight % to about 60 weight %, about 1 weight % to about 50 weight %, about 1 weight % to about 30 weight % or about 30 weight % to about 60 weight % based on the total weight of the carbon particles. The metal precursor may have a weight percentage of about 50 weight %, based on the total weight of the carbon particles.

The amino additive may have a weight percentage in the range of about 1 weight % to about 90 weight %, about 5 weight % to about 90 weight %, about 10 weight % to about 90 weight %, about 20 weight % to about 90 weight %, about 30 weight % to about 90 weight %, about 50 weight % to about 90 weight %, about 5 weight % to about 50 weight %, about 5 weight % to about 30 weight %, about 5 weight % to about 20 weight %, about 5 weight % to about 10 weight %, about 10 weight % to about 50 weight % or about 20 weight % to about 30 weight %, based on the total weight of the carbon particles.

The solvent may be an aqueous medium. The solvent may comprise a combination of water and a water miscible solvent selected from the group consisting of ethanol, acetone, tetrahydrofuran, isopropyl alcohol and combinations thereof. The solvent may be water.

The dispersion may further comprise an inorganic salt. Advantageously, the inorganic salt may activate or promote an oxidation reaction of the metal of the metal precursor. Therefore, the composite material prepared by the method may have improved oxygen scavenging properties.

The inorganic salt may be an electrolyte. The inorganic salt may be a halide. Non-limiting examples of the inorganic salt include NaCl, CaCl₂), MgCl₂, ZnCl₂, CuCl₂ and combinations and hydrates thereof.

The inorganic salt may be NaCl. Advantageously, NaCl has higher effectiveness than other inorganic salts. NaCl is also safer and cheaper compared to other inorganic salts.

The inorganic salt may have a weight percentage in the range of about 0 weight % to about 20 weight %, about 0.1 weight % to about 20 weight %, about 10 weight % to about 20 weight %, about 0 weight % to about 10 weight % or about 0.1 weight % to about 10 weight %, based on the total weight of the composite material.

The forming step (a) may be undertaken by stirring or sonicating. The forming step (a) may additionally or alternatively be undertaken by an incipient wetness impregnation method, where the carbon particles are sufficiently immersed in the solvent with an appropriate amount of the metal precursor to ensure that the metal precursor is absorbed onto the carbon particles. The forming step (a) may be undertaken by stirring the carbon particles, the metal precursor, the amino additive, the solvent, the inorganic salt (where present) for a duration in the range of about 1 hour to about 24 hours.

In the forming step (a), the carbon particles, the metal precursor, the amino additive, the solvent and the inorganic salt (where present) may be provided concurrently or sequentially. The forming step (a) may be undertaken by stirring a combination of the carbon particles and the solvent for a duration of about 12 hours, followed by adding the metal precursor into the combination and stirring the combination for a duration of about 10 minutes, followed by adding the amino additive into the combination and stirring the combination for a duration of about 30 minutes.

The drying step (b) may be undertaken by a drying method selected from the group consisting of freeze drying, spray drying, vacuum drying and combinations thereof. The drying step (b) may be undertaken by sequentially drying the dispersion of step (a) via spray drying and vacuum drying (such as using a vacuum oven).

Where the drying step (b) comprises spray drying of the dispersion of step (a), the composite material may be in a form of cluster. The cluster may be a spherical cluster.

Where the drying step (b) comprises freeze drying of the dispersion of step (a), the composite material may be in a form of particles.

In the heating step (c), the inert gas may be selected from the group consisting of helium, nitrogen, argon, krypton and combinations thereof.

The atmosphere may further comprise hydrogen. Therefore, the atmosphere may be forming gas.

Advantageously, where the atmosphere comprises hydrogen, the composite material may be formed with at least about 20% higher yield compared to where the atmosphere does not comprise hydrogen. This is because the metal precursor can be converted to a reduced form at a lower temperature in the presence of hydrogen, which would increase the yield of the composite material. Where the metal precursor comprises Fe³⁺, the metal precursor may be converted to Fe⁰ at a lower temperature in the presence of hydrogen.

The heating step (c) may be undertaken by providing a flow of the atmosphere that flows through the dried powder of step (b). The flow of the atmosphere may comprise a flow of argon having a flow rate of about 180 sccm and a flow of hydrogen having a flow rate of about 20 sccm.

The heating step (c) may be undertaken at a heating temperature in the range of about 400° C. to about 1000° C., about 600° C. to about 1000° C., about 800° C. to about 1000° C., about 400° C. to about 800° C., about 400° C. to about 600° C., about 500° C. to about 900° C., about 600° C. to about 800° C. or about 500° C. to about 700° C. The heating temperature may be about 600° C. or about 800° C.

The heating temperature may be suitably selected based on the atmosphere. Where the atmosphere consists of nitrogen, the heating temperature may be about 800° C. Where the atmosphere comprises nitrogen and hydrogen, the heating temperature may be about 600° C.

The heating temperature may be reached via a ramping rate in the range of about 1° C./minute to about 10° C./minute, about 5° C./minute to about 10° C./minute or about 1° C./minute to about 5° C./minute. The ramping rate may be about 5° C./minute.

The heating step (c) may be undertaken for a duration in the range of about 0.5 hour to about 10 hours, about 1 hour to about 10 hours, about 3 hours to about 10 hours or about 1 hour to about 3 hours. The heating step (c) may be undertaken for a duration of about 3 hours.

The heating step (c) may be undertaken in a tube furnace.

The heating step (c) may convert the metal precursor of the forming step (a) into metal particles. The metal particles may have zero valency. Thus, the metal particles may react with oxygen and may improve the composite material's oxygen scavenging property.

The method may further comprise a step (d) of modifying the composite material after the heating step (c) with an organic acid.

Advantageously, the composite material prepared by the method may have improved oxygen scavenging properties where the organic acid is present as the organic acid may facilitate a conversion of metal from its higher oxidation state to lower oxidation state. The organic acid may reduce Fe³⁺ to Fe²⁺, which reacts with oxygen to show high oxygen scavenging capacity.

Non-limiting examples of the organic acid include polyacrylic acid, polymethacrylic acid, ascorbic acid and combinations thereof.

The organic acid may have a weight percentage in the range of about 0 weight % to about 25 weight %, about 5 weight % to about 20 weight % or about 10 weight % to about 15 weight %, based on the total weight of the composite material.

As carboxylic acid moieties are formed from the additives (where present) during the treating step (a), the organic acid may be alternatively or additionally derived from the additives.

The modifying step (d) may comprise the steps of:
(d1) dispersing the composite material of the heating step (c), the organic acid of the treating step (a) (where present) and a dispersant to form a dispersion; and
(d2) drying the dispersion of the dispersing step (d1).

In the dispersing step (d1), the organic acid may be provided at a weight percentage in the range of about 0.1 weight % to about 25 weight %, about 5 weight % to about 20 weight % or about 10 weight % to about 15 weight %, based on the total weight of the composite material of the heating step (c).

The dispersant may be an aqueous medium. The dispersant may comprise a combination of water and a water miscible solvent selected from the group consisting of ethanol, acetone, tetrahydrofuran, isopropyl alcohol and combinations thereof. The dispersant may be water.

The dispersing step (d1) may be undertaken under a flow of an inert gas.

The dispersing step (d1) may be undertaken using a mechanical stirrer, a ball miller or a homogenizer.

The drying step (d2) may be undertaken by a drying method selected from the group consisting of freeze drying, spray drying, vacuum drying and combinations thereof.

The modifying step (d) may alternatively comprise the step of mixing the composite material of step (c) and the organic acid of step (a). The mixing step may be undertaken using a ball miller.

Exemplary, non-limiting embodiments of a composite material will now be disclosed.

The composite material comprises a carbon support and a plurality of metal particles, wherein the metal particles are disposed within the carbon support.

Advantageously, the composite material may have high oxygen scavenging properties. This is because the uniform distribution of Fe⁰ in the carbon support with high Fe⁰ content.

The composite material may be in the form of a cluster or particles.

In the composite material, the carbon support may be porous having a pore size that is not particularly limited. The carbon support may be macroporous, mesoporous or microporous.

The carbon support may act as a support for the metal particles. Where the metal particles are smaller in size as compared to the pore size of the carbon support, the metal particles may be impregnated within pores of the carbon support.

The carbon support may act as a protector for the metal particles. Where the metal particles are smaller in size as compared to the carbon support, the metal particles may be embedded within the carbon support such that the metal particles can be regarded as having a layer of carbon coating around the metal particles. This may then protect the metal particles from oxidation.

The carbon support may be made up of a skeleton derived from a number of carbon particles that are linked by carbon converted from an amino additive. Thus, some of the metal particles may be distributed in the out layer of the carbon particles and some metal particles may be distributed in the carbon linkers between the carbon particles.

The metal particle may have a particle size of less than about 100 nm, less than about 50 nm, less than about 30 nm or less than about 20 nm. Where the metal particle is spherical, the particle size may refer to the diameter of the metal particle, or where the metal particle is an irregularly shaped particle, the particle size may refer to the equivalent diameter of the irregularly shaped metal particle.

The metal particles in the out layer of the carbon particles may have a particle size of less than about 100 nm, less than about 50 nm, less than about 30 nm or less than about 20 nm.

The metal particle distributed in the carbon linkers between the carbon particles may have a particle size of less than about 30 nm or less than about 20 nm. During conversion of the amino additive to the carbon linker, the metal particles are covered by the amino additive, limiting the particle size of the metal particles that are present in the eventual carbon linkers. Due to the smaller particle size of the metal particles in the carbon linkers, the composite material may have a high oxygen scavenging capacity.

Advantageously, the oxygen scavenging capacity of the composite material may be in the range of about 100 cm³/g to about 200 cm³/g, about 120 cm³/g to about 200 cm³/g, about 160 cm³/g to about 200 cm³/g, about 100 cm³/g to about 160 cm³/g, about 100 cm³/g to about 120 cm³/g or about 120 cm³/g to about 160 cm³/g as measured by Headspace Gas Analyser (Gaspace Advance GS3 Micro).

In the composite material, the metal particles may have a weight percentage in the range of about 1 weight % to about 80 weight %, about 30 weight % to about 80 weight %, about 50 weight % to about 80 weight %, about 60 weight % to about 80 weight %, about 1 weight % to about 60 weight %, about 1 weight % to about 50 weight %, about 1 weight % to about 30 weight % or about 30 weight % to about 60 weight %, based on the total weight of the carbon particles. The metal precursor may have a weight percentage of about 50 weight % based on the total weight of the carbon support.

The composite material may further comprise an inorganic salt. Advantageously, the inorganic salt may activate or promote an oxidation reaction of the metal particles. Therefore, the composite material may have improved oxygen scavenging properties.

The inorganic salt may be an electrolyte. The inorganic salt may be a halide. Non-limiting examples of the inorganic salt include NaCl, CaCl₂), MgCl₂, ZnCl₂, CuCl₂ and combinations and hydrates thereof.

The inorganic salt may be NaCl. Advantageously, NaCl has higher effectiveness than other inorganic salts. NaCl is also safer and cheaper compared to other inorganic salts.

The inorganic salt may have a weight percentage in the range of about 0 weight % to about 20 weight %, about 10 weight % to about 20 weight % or about 0 weight % to about 10 weight % based on the total weight of the composite material.

The composite material may further comprise an organic acid. Advantageously, the composite material may have improved oxygen scavenging properties where the organic acid is present as the organic acid may facilitate a conversion of metal from higher oxidation state to lower oxidation state. The organic acid may reduce Fe³⁺ to Fe²⁺. which react with oxygen to show high oxygen scavenging capacity.

Non-limiting examples of the organic acid include polyacrylic acid, polymethacrylic acid, ascorbic acid and combinations thereof.

The organic acid may have a weight percentage in the range of about 0 weight % to about 25 weight %, about 5 weight % to about 20 weight % or about 10 weight % to about 15 weight %, based on the total weight of the composite material.

Exemplary, non-limiting embodiments of a composite material will now be disclosed.

The composite material may be prepared by the method as described herein Exemplary, non-limiting embodiments of an article will now be disclosed.

The article comprises the composite material as described herein.

Advantageously, the article may scavenge oxygen residues highly efficiently due to the oxygen scavenging properties of the composite material.

The article may have a form that can enclose the composite material. Non-limiting examples of the form include a sachet, a bag, a film, a sheet, a coating and the like.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic illustration of a method of preparing carbon particles according to the present disclosure.

FIG. 2A is a scanning electron microscope (SEM) image of an embodiment of carbon particles according to the present disclosure at ×10,000 magnification.

FIG. 2B is a SEM image of the carbon particles as shown in FIG. 2A at ×20,000 magnification.

FIG. 3 is a SEM image of an embodiment of a composite material according to the present disclosure at ×3,000 magnification.

FIG. 4A is a SEM image of another embodiment of a composite material according to the present disclosure at ×3,000 magnification.

FIG. 4B is a SEM image of the composite material as shown in FIG. 4A at ×7,000 magnification.

FIG. 5 shows X-ray diffraction (XRD) patterns of composite materials according to the present disclosure.

FIG. 6 is a SEM image of another embodiment of a composite material according to the present disclosure at ×1,000 magnification.

FIG. 7 is a SEM image of another embodiment of a composite material according to the present disclosure at ×2,000 magnification.

FIG. 8 shows a Barrett-Joyner-Halenda (BJH) desorption curve of another embodiment of a composite material according to the present disclosure.

### EXAMPLES

Non-limiting examples of the invention will be further described in greater detail by reference to specific Examples, which should not be construed as in any way limiting the scope of the invention.

### Example 1—Preparation of Lignin Solution with pH of 8

10 g of lignin (purchased from Sigma Aldrich, Singapore) was dispersed in 80 g of deionized water and stirred overnight to form a solution. The pH value of the solution was adjusted to about 10 using 20 mL of 1 M NaOH (purchased from Sigma Aldrich, Singapore). The solution was left to stir for 2 hours. 12.8 mL of 1 M HCl (purchased from Sigma Aldrich, Singapore) was then added and stirred overnight. The solution was centrifuged at 9,000 rpm for 15 minutes to remove the insoluble residue. The total weight of lignin solution was 122.8 g (lignin concentration: about 8 weight %). The lignin solution had a final pH value of about 8 as measured by a pH meter from Mettler Toledo (Model: Seven Compact S210).

### Example 2—Preparation of Surface Porous Carbon Spheres from Lignin

4 mg of KH₂PO₄ (purchased from Sigma Aldrich, Singapore, ACS reagent, >99%) was dissolved into 21 g of water, mixed with 20 g of lignin solution prepared in Example 1 and stirred overnight (lignin concentration: about 4 weight %). The solution of transferred into a hydrothermal reactor and placed in the oven at 210° C. for 2.5 hours. The reacted solution was centrifuged at 9,000 rpm for 1 hour to collect the carbon spheres which was further washed twice with deionized water (under vigorous stirring for 10 minutes to make sure the water-soluble part can be washed off completely). The carbon sphere was dried in an oven at 60° C. for 2 days.

### Example 3—Preparation of Surface Porous Carbon Spheres from Lignin and Glucose (5 Weight %)

4 mg of KH₂PO₄ (≥99%, purchased from Sigma Aldrich, Singapore, used similarly as described in Example 2) and 0.1 g of glucose (ACS reagent, purchased from Sigma Aldrich, Singapore) were dissolved into 21 g of water, mixed with 20 g of lignin solution prepared in Example 1 and stirred overnight (lignin concentration: about 4 weight %). The solution was transferred into a hydrothermal reactor and placed in the oven at 210° C. for 2.5 hours. The reacted solution was centrifuged at 9,000 rpm for 1 hour to collect the carbon spheres which were further washed twice with deionized water (under vigorous stirring for 10 minutes to make sure the water-soluble part can be washed off completely). The carbon sphere was dried in an oven at 60° C. for 2 days.

### Example 4—Preparation of Fe@Carbon Particles

5 g of surface porous carbon spheres prepared in Example 2 or 3 was dispersed into 200 g water through stirring overnight at 700 rpm to form a solution.

14 g of Fe(NO₃)₃ (≥98%, purchased from Sigma Aldrich, Singapore) was dissolved in 33.33 g of water and mixed into the carbon sphere solution prepared above under homogenization at 10,000 to 15,000 rpm for 10 minutes.

1 g of glucosamine (≥99%, purchased from Sigma Aldrich, Singapore) was mixed into the solution prepared above and stirred for 30 minutes. The solution obtained was freeze-dried to collect carbon particles impregnated with Fe³⁺, which were further dried in an oven at 60° C. overnight to become a powder form.

The dried carbon powder was then placed in a quartz tube inside a tube furnace and heated to 600° C. with a ramping rate of 5° C./minute, under argon flow at a flow rate of 180 sccm and hydrogen flow at a flow rate of 20 sccm. The sample was kept at 600° C. for 3 hours. After that, the sample was allowed to cool to ambient temperature under argon before removing from the tube furnace. The as synthesized nanostructured Fe@carbon particles were ready for characterization.

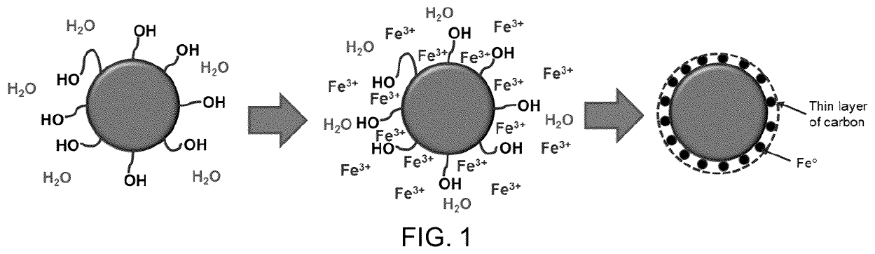

A schematic illustration of the method used to prepare Fe@carbon particles is provided in FIG. 1.

### Example 5-Preparation of Fe@Carbon Cluster

5 g of surface porous carbon spheres prepared in Example 2 or 3 was dispersed into 200 g water through stirring overnight at 700 rpm to form a solution.

14 g of Fe(NO₃)₃ (>98%, purchased from Sigma Aldrich, Singapore) was dissolved in 33.33 g of water and mixed into the carbon sphere solution prepared above under homogenization at 10,000 to 15,000 rpm for 10 minutes.

1 g of glucosamine was mixed into the solution prepared above and stirred for 30 minutes. The solution obtained was sprayed using BUCHI B-290 Mini Spray Dryer to collect carbon clusters impregnated with Fe³⁺, which were further dried in an oven at 60° C. overnight to become a powder form.

The dried carbon powder was then placed in a quartz tube inside a tube furnace and heated to 600° C. with a ramping rate of 5° C./minute, under argon flow at a flow rate of 180 sccm and hydrogen flow at a flow rate of 20 sccm. The sample was kept at 600° C. for 3 hours. After that, the sample was allowed to cool to ambient temperature under argon before removing from the tube furnace. The as synthesized nanostructured Fe@carbon clusters were ready for characterization.

### Example 6-Characterization and Analysis of Materials

### Scanning Electron Microscope (SEM)

SEM was performed with a filed emission scanning electron microscope (JEOL JSM-6700F FESEM) under an acceleration voltage of 5 kV. All samples were placed on a carbon tape that was affixed to the sample holder and gold-coated before observation.

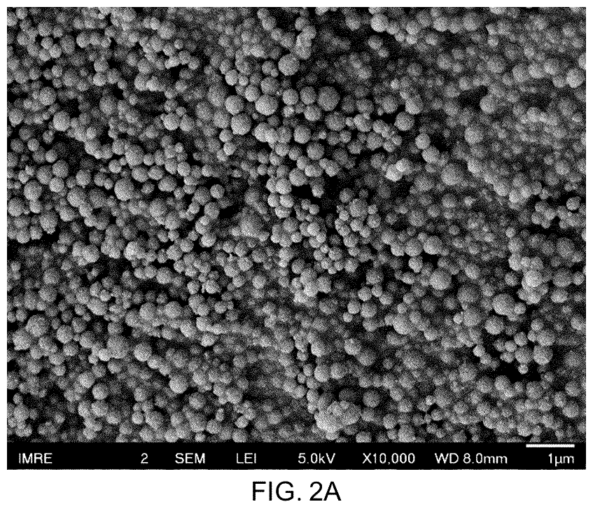

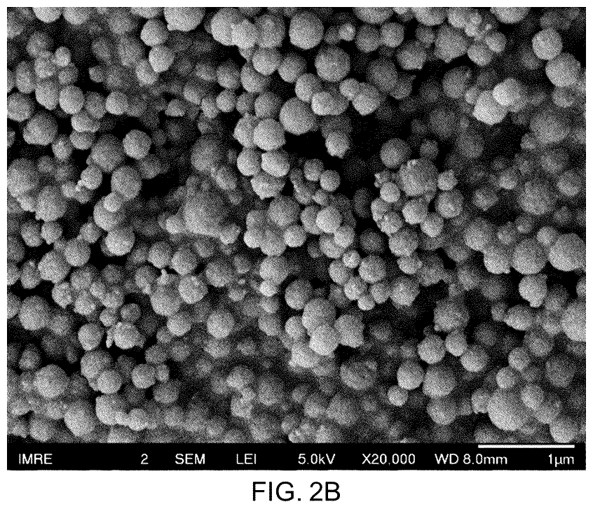

As shown in FIGS. 2A and 2B, SEM images of carbon spheres prepared from lignin at a pH value of 8 showed the surface porous structure and that the synthesized surface porous carbon spheres derived from lignin as described above may have a particle size ranging from 100 nm to 800 nm, depending on reaction temperature, pH value of lignin solution, content of glucose and solid concentration of the reaction solution. In order to control the size of the carbon spheres, salts such as KH₂PO₄ were added into the reaction mixture as nucleating agents, at 0.1 to 5 weight % of lignin or 0.2 to 1 weight % of lignin. The salt may be selected from NaCl, Na₂CO₃, Na₃PO₄, KCl, K₂SO₄, K₂CO₃ and Na₂SO₄. The size of carbon spheres may be easily fine-tuned by changing the lignin concentrations and the reaction temperature.

Table 1 shows the dependence of the production yield of carbon spheres on the pH value of reaction solutions, the amount of glucose added and the post-treatment adjustment of the pH value of the production solution to 1. As shown in Table 1, the product yield of the carbon spheres varied from 58% to 77% with the maximal yield of above 77%, depending on the parameters as described above.

TABLE 1
Dependence of carbon sphere production yield on the pH value
of reaction solution, amount of glucose and the post-treatment
adjustment of the pH value of the production solution to 1.

| | Composition | | | | | | | | | | | |
|---|---|---|---|---|---|---|---|---|---|---|---|---|
| | | | | | Lignin (95) + | | | | Lignin (90) + | | | |
| | Pure lignin | | | | glucose (5) | | | | glucose (10) | | | |
| | pH | | | | | | | | | | | |
| | 7 | | 8 | | 7 | | 8 | | 7 | | 8 | |
| Post- | W/O | W | W/O | W | W/O | W | W/O | W | W/O | W | W/O | W |
| treatment* | | | | | | | | | | | | |
| Yield (%) | 58 | 65 | 64 | 77 | X | X | 68 | 75 | X | X | 58 | 71 |

*W/O: without post-treatment adjustment of pH value to about 1; W: with post-treatment adjustment of pH value to about 1.

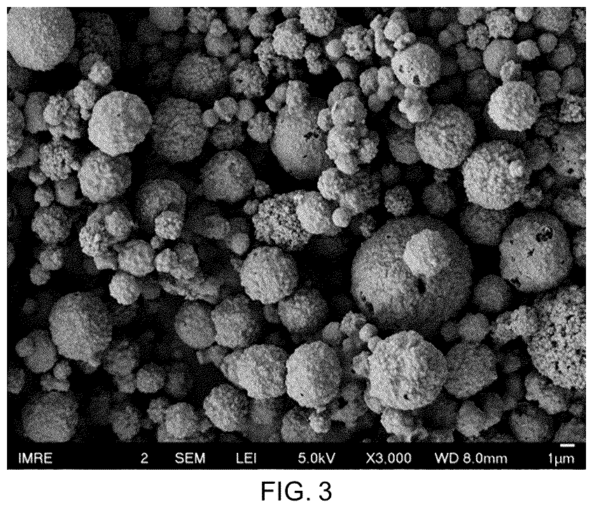

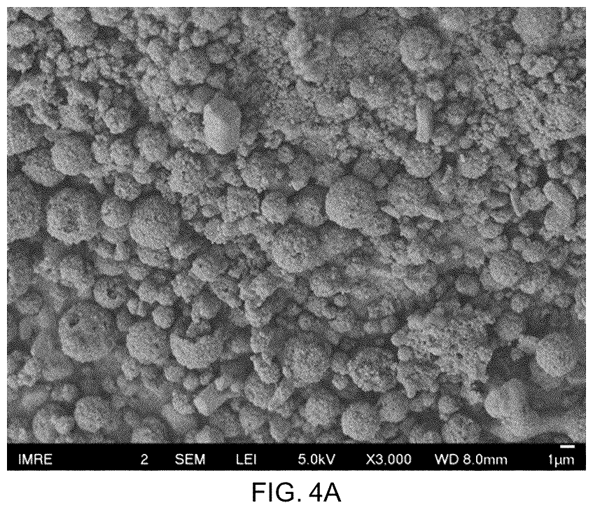

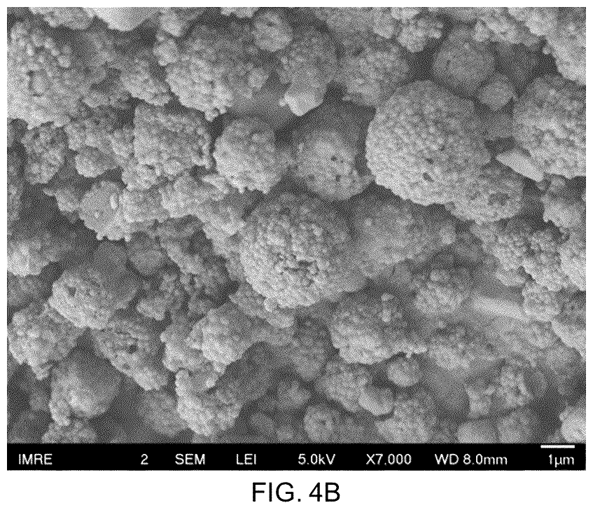

Clusters of carbon spheres impregnated with Fe³⁺ prepared as described above are shown in FIG. 3. The structure of the clusters after pyrolysis are shown in FIGS. 4A and 4B.

### X-Ray Diffraction (XRD)

The structure characteristic and crystalline phase of samples was evaluated by X-Ray diffraction (XRD) analysis. The analysis was performed using a Bruker D8 General Area Detector Diffraction System (GADDS) XRD using Cuka radiation (k=0.154 nm) with a scanning angle ranging from 20 to 86°.

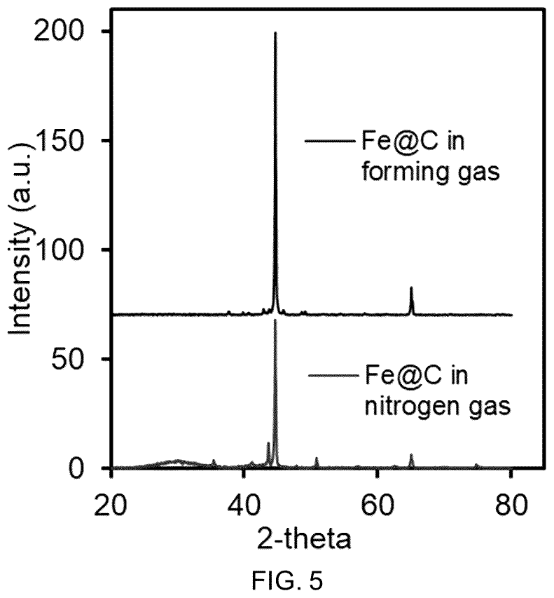

The carbon in the clusters not only serves as a support for iron, but also acts as a reducing agent in the carbon-thermal reaction process (i.e., the heating step in the furnace as described above). The reduction process is endothermic with gases (mainly carbon dioxide) as by-products. As shown in FIG. 5, iron particles supported on the carbon clusters showed predominant body centered cubic α-Fe at 2θ of 44 and 65°, which indicated the formation of zero-valent iron particles.

### Oxygen Scavenging Analysis Test

25 mL of glass conical flasks were used as sample containers (model packaging) to characterise the oxygen scavenging property of the samples. The full capacity of the flask was initially filled with air (with about 20.90% O₂) at ambient condition. One 2 mL vial containing 1 ml of water was placed inside the flask to adjust the room humidity (RH) to 100%. Approximately 0.03 to 0.05 g of Fe⁰@carbon sample with or without sodium chloride (120 μL NaCl solution, purchased from Sigma Aldrich, Singapore) was placed inside the flask. The flask was then sealed by a gas-tight rubber septum stopper (Suba-Seal, W. Freeeman & Co. Ltd, UK) and placed at room temperature for the duration of the oxygen scavenging experiment. The oxygen content in the flask headspace (% O₂) was analysed by a headspace oxygen/carbon dioxide analyser (model GS3, Systec Illinois, United States of America; accuracy to 0.005% O₂) in a procedure in which an aliquot of the headspace gas was taken out and analysed using a zirconium-based sensor (provided with the gas analyser). A sampling needle with a 0.45 μm PTFE filter was inserted and about 0.875 mL headspace gas were sampled through the stopper. Calibration of headspace analyser was done using ambient air after each sample measurement. Oxygen uptake (represented as mass of oxygen consumed/mass of sample) was calculated indirectly from the decrease in the oxygen content in the headspace of the flasks over time.

It is important to highlight that carbon particles as described above stabilized the zero-valent iron from further oxidation, even after exposure to ambient conditions for long hours. This criterion is very important to ensure high stability and lifetime of scavenger during storage. The Fe⁰@Carbon products as described above were easily handled in air since there was no significant reaction of Fe⁰@Carbon with air at ambient conditions. In contrast, iron particles prepared by chemical reduction process using an excess of reducing agent such as sodium borohydride are easily oxidized and react with air.

Therefore, the Fe⁰@Carbon products as described above exhibited very good oxygen scavenging property. Iron and its compounds are used in many oxygen absorbents when trace amount of water are present in the packaging according to the reaction below.

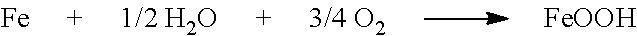

As observed after the test, Fe⁰@Carbon samples were quite stable with a very slow rate of uptake and low capacity of oxygen absorption at 100% RH. The presence of a trace amount of NaCl (~10 wt % based on the dry weight of Fe/C), either added as a solid or dissolved in a minimum amount of water (~30-50 μl) abruptly increased the rate of oxygen uptake. It was feasible to control the oxygen scavenging rate and oxygen scavenging capacity in a package (known volume) by adjusting the Fe^{o}@Carbon, NaCl and moisture concentrations. Particularly, oxygen scavenging capacity at a range of 40 to 78 cm³/g was achieved for the present materials, with the highest oxygen absorption performance at 78 cm³/g. It was believed that high surface areas of carbon particle and its glucose polymer chains binding with Fe³⁺ ions were important to obtain a uniform dispersion of iron nanoparticles on the carbon supports, which thereby improved the oxygen scavenging property.

In addition, as shown in Table 2, the oxygen scavenging capacity of the Fe@carbon clusters prepared in the presence of glucosamine was much higher, which was due to the uniform distribution of Fe⁰ with aggregation in the carbon support.

TABLE 2
Oxygen scavenging capacity of Fe@carbon
cluster prepared with and without glucosamine.

| | | | Pyrolysis | Scavenging |
|---|---|---|---|---|
| | | | condition | capacity |
| | Fe(NO₃)₃•9H₂O | Glucosamine | (gas/ | (cc/g of |
| Sample # | (g) | (g) | temperature) | scavenger) |
| 1 | 11 | 0 | N₂/800° C. | 58.0 |
| 2 | 11 | 0.8 | N₂/800° C. | 88.6 |

Carbon sphere weight: 5 g; water volume: 225 mL

Further, as shown in Table 3, decreasing pH of the lignin solution led to improved yield after hydrothermal reaction.

TABLE 3
Improvement of production yield of
carbon particles by acidification.

| | | pH before | Production |
|---|---|---|---|
| | With HCl | hydrothermal | yield |
| Sample | treatment? | reaction | (%) |
| Pure lignin pH 10 | N | 10.2 | <5 |
| Pure lignin pH 9 | Y | 9 | 36.9 |
| Pure lignin pH 8 | Y | 8.0 | 66.1 |
| Pure lignin pH 7 | Y | 7.8 | Solution unstable |
| | | | and solidified |
| | | | rapidly |

### Example 7—Preparation of Carbon Spheres from Glucose Via Hydrothermal Treatment

180 g of D-(+)-glucose (>99.5%, GC, purchased from Sigma Aldrich, Singapore) was dissolved in 1500 mL of deionized water and stirred at room temperature for 30 minutes to form a solution. 0.05 to 0.5 weight % of KH₂PO₄ was added and stirred for additional 5 minutes. The mixed solution was then transferred into a Parr high pressure reactor (3.75 litres in capacity). The reactor was heated to about 200 to 210° C. for a period of about 0 to 30 minutes, and then allowed to cool to room temperature. The particles were then washed with deionized water for 3 times by centrifugation at 9,000 rpm for 15 minutes each. The carbon spheres obtained were then dried in an oven at 60° C. for 2 days.

### Example 8—Preparation of Fe@Carbon Cluster Via Pyrolysis in N₂

5 g of carbon spheres prepared in Example 7 was dispersed in 66 mL of deionized water under stirring to form a suspension. 30 mL of Fe(NO₃)₃ water solution (with 28.8 g Fe(NO₃)₃·9H₂O, ≥98%, purchased from Sigma Aldrich, Singapore) was added into the carbon sphere suspension prepared above and stirred at 750 rpm overnight. Then 4 g of glucosamine was mixed into the suspension prepared above and stirred for 30 minutes. The obtained suspension was sprayed using BUCHI B-290 Mini Spray Dryer. The collected carbon clusters impregnated with Fe³⁺ were dried in a vacuum oven at 60° C. overnight.

The dried carbon powder was then placed in a quartz tube inside a tube furnace and heated to 800° C. with a ramping rate of 5° C./minute, under N₂ flow at a flow rate of 200 sccm. The sample was kept at 800° C. for 3 hours. Afterwards, the sample was allowed to cool to ambient temperature under N₂ before removing from the tube furnace. The as synthesized Fe@carbon clusters were ready for characterization.

### Example 9—Preparation of Fe@Carbon Cluster Via Pyrolysis in Forming Gas

5 g of carbon spheres prepared in Example 7 was dispersed in 66 mL of deionized water under stirring to form a suspension. 30 mL of Fe(NO₃)₃ water solution (with 28.8 g Fe(NO₃)₃·9H₂O) was added into the carbon sphere suspension prepared above and stirred at 750 rpm overnight. Then 4 g of glucosamine was mixed into the suspension prepared above and stirred for 30 minutes. The obtained suspension was sprayed using BUCHI B-290 Mini Spray Dryer. The collected carbon clusters impregnated with Fe³⁺ were dried in a vacuum oven at 60° C. overnight.

The dried carbon powder was then placed in a quartz tube inside a tube furnace and heated to 800° C. with a ramping rate of 5° C./minute, under nitrogen flow at a flow rate of 180 sccm and hydrogen flow at a flow rate of 20 sccm. The sample was kept at 800° C. for 3 hours. Afterwards, the sample was allowed to cool to ambient temperature under N₂ before removing from the tube furnace. The as synthesized Fe@carbon clusters were ready for characterization.

### Example 10-Preparation of Fe@Carbon Cluster Incorporated with NaCl Via Pyrolysis in Forming Gas

5 g of carbon spheres prepared in Example 7 was dispersed in 66 mL of deionized water under stirring to form a suspension. 30 mL of Fe(NO₃)₃ water solution (with 28.8 g Fe(NO₃)₃·9H₂O) was added into the carbon sphere suspension prepared above and stirred at 750 rpm overnight. Then 4 g of glucosamine was mixed into the suspension prepared above, followed by the addition of 0.75 g of NaCl and the suspension was stirred for 30 minutes. The obtained suspension was sprayed using BUCHI B-290 Mini Spray Dryer. The collected carbon clusters impregnated with Fe³⁺ were dried in a vacuum oven at 60° C. overnight.

The dried carbon powder was then placed in a quartz tube inside a tube furnace and heated to 800° C. with a ramping rate of 5° C./minute, under nitrogen flow at a flow rate of 180 sccm and hydrogen flow at a flow rate of 20 sccm. The sample was kept at 800° C. for 3 hours. Afterwards, the sample was allowed to cool to ambient temperature under N₂ before removing from the tube furnace. The as synthesized Fe@carbon clusters were ready for characterization.

### Example 11—Characterization and Analysis of Materials

### Scanning Electron Microscope (SEM)

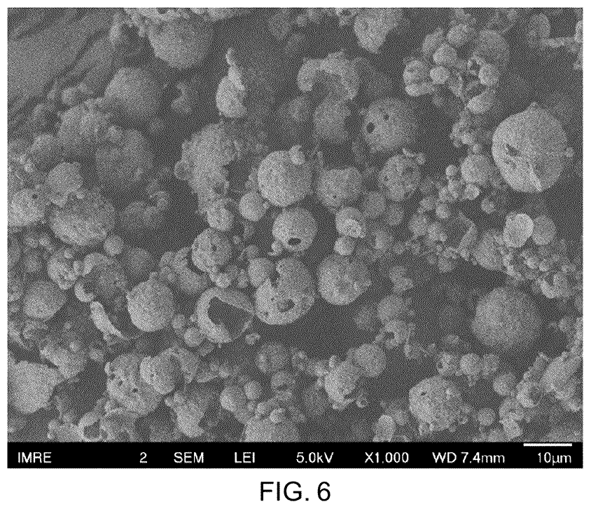

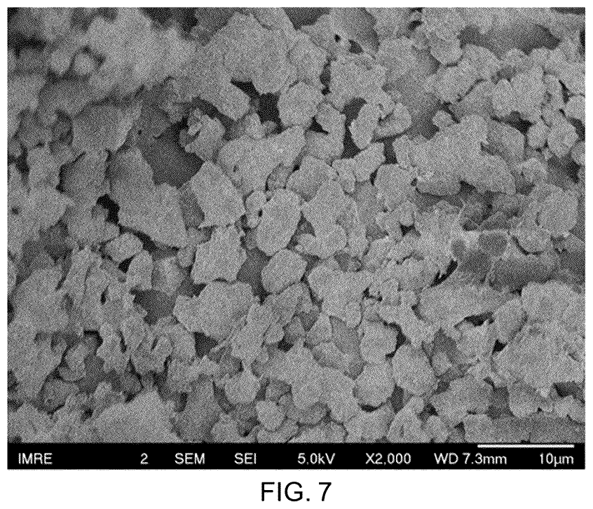

SEM was performed as described in Example 6. The SEM image of carbon sphere clusters impregnated with Fe³⁺ and prepared from carbon spheres and glucosamine is shown in FIG. 6. The SEM image of mesoporous Fe@carbon clusters as described in Example 8 is shown in FIG. 7.

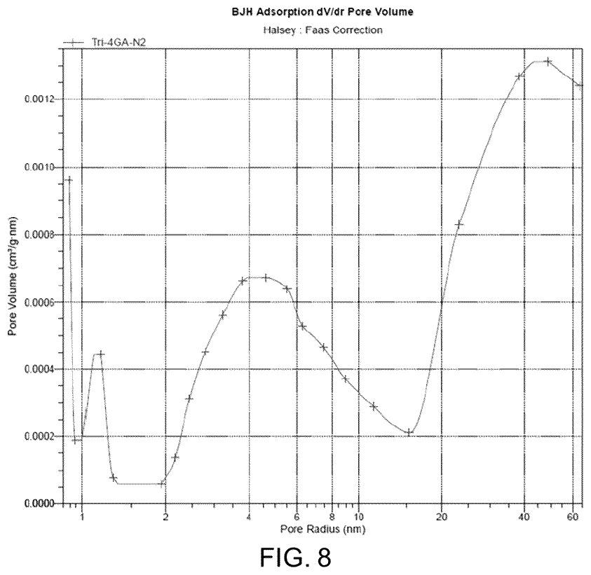

In addition, FIG. 8 shows the BJH desorption curve of Fe@carbon clusters, which demonstrates that the pores in Fe@carbon clusters comprises micropores, mesopores and macropores, among which the mesoporous structure contributes significantly to the oxygen scavenging performance.

### Transmission Electron Microscope (TEM) Imaging

TEM and energy dispersive X-ray (EDX) analysis were performed with a transmission electron microscope (JEOL 2100 TEM) under and acceleration voltage of 200 kV. All samples were first dispersed and diluted with ethanol and then dropped on a 200-mesh carbon coated copper grid and dried at room temperature before observation.

### Physical Adsorption/Desorption of N₂

The N₂ adsorption/desorption was carried out at 77 K using Micromeritics ASAP 2020 to study the pore texture and specific surface area of the carbon samples. Surface area was calculated by using the multiple-point Brunauer-Emmett-Teller (BET) model. Porosity distributions were calculated by the non-local density functional theory (NLDFT) method.

### Oxygen Scavenging Analysis Test

25 mL of glass conical flasks were used as sample containers (model packaging) to characterise the oxygen scavenging property of the samples. The full capacity of the flask was initially filled with air (with about 20.90% O₂) at ambient condition. One 2 mL vial containing 1 mL of water was placed inside the flask to adjust the room humidity (RH) to 100%. Approximately 0.03 to 0.05 g of Fe⁰ @carbon sample with or without sodium chloride (120 μL NaCl solution, purchased from Sigma Aldrich, Singapore) was placed inside the flask. The flask was then sealed by a gas-tight rubber septum stopper (Suba-Seal, W. Freeeman & Co. Ltd, UK) and placed at room temperature for the duration of the oxygen scavenging experiment. The oxygen content in the flask headspace (% O₂) was analysed by a headspace oxygen/carbon dioxide analyser (model GS3, Systec Illinois, United States of America; accuracy to 0.005% O₂) in a procedure in which an aliquot of the headspace gas was taken out and analysed using a zirconium-based sensor (provided with the analyser). A sampling needle with a 0.45 μm PTFE filter was inserted and about 0.875 mL headspace gas were sampled through the stopper. Calibration of headspace analyser was done using ambient air after each sample measurement. Oxygen uptake (represented as mass of oxygen consumed/mass of sample) was calculated indirectly from the decrease in the oxygen content in the headspace of the flasks over time.

The production yield and oxygen scavenging capacity of Fe@carbon clusters prepared as described above are shown in Table 4.

TABLE 4
Production yield and oxygen scavenging capacity of
Fe@carbon clusters prepared as described herein.

| | | | | | Fe@carbon cluster | |
|---|---|---|---|---|---|---|
| | | | | Pyrolysis | Yield | Scavenging |
| | Solution composition¹ | | | condition | after | capacity |
| | Fe(NO₃)₃•9H₂O | Glucosamine | NaCl | (gas/ | pyrolysis | (cc/g of |
| Sample # | (g) | (g) | (g) | temperature) | (%) | scavenger) |
| 1 | 28.8 | 4 | 0.75 | N₂/800° C. | 24 | 156 |
| 2 | 28.8 | 4 | 0 | N₂/800° C. | 22.5 | 101 |
| 3 | 28.8 | 5 | 0.75 | N₂/800° C. | 22.3 | 148 |
| 4 | 28.8 | 4 | 0.75 | N₂•H₂/600° C. | 32 | 146 |
| 5 | 36.0 | 4 | 0.94 | N₂•H₂/600° C. | 35 | 145 |
| 6 | 43.2 | 4 | 1.12 | N₂•H₂/600° C. | 35 | 150 |
| 7 | 28.8 | 4 | 1.5 | N₂•H₂/600° C. | 37.4 | 121 |
| 8² | 28.8 | 4 | 0.75 | N₂•H₂/600° C. | 40 | 150 |

¹Carbon sphere weight: 5 g; water volume: 30 mL.
²Carbon sphere cluster was vacuum-dried for 4 days at 60° C.

### INDUSTRIAL APPLICABILITY

The carbon particles and composite materials of the disclosure may be used in a variety of applications such as food, beverage and pharmaceutical applications as well as wherever anaerobic environment is required, specifically packaging of the above.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of preparing carbon particles, comprising the steps of:
(a) treating a mixture comprising (i) an inorganic salt and (ii) a solution comprising a carbon source hydrothermally to form a solution of carbon particles; and
(b) collecting the carbon particles from the solution of the treating step (a).

2. The method of claim 1, further comprising, before the treating step (a), the steps of:
(a1) acidifying a solution comprising the carbon source, a base and a solvent; and
(a2) mixing the inorganic salt and the solution of the acidifying step (a1) to form the mixture.

3. The method of claim 1, wherein the solution of the treating step (a) further comprises an additive.

4. The method of claim 1, wherein the carbon source of the treating step (a) is derived from a biomass material.

5. The method of claim 4, wherein the biomass material is lignin or glucose.

6. The method of claim 1, wherein the treating step (a) is undertaken at a temperature in the range of 150° C. to 220° C.

7. The method of claim 1, further comprising a step of adjusting a pH value of the solution of the treating step (a) after the treating step (a) but before the collecting step (b).

8. Carbon particles prepared from a method comprising the steps of:
(a) treating a mixture comprising (i) an inorganic salt and (ii) a solution comprising a carbon source hydrothermally to form a solution of carbon particles; and
(b) collecting the carbon particles from the solution of the treating step (a).

9. A method of preparing a composite material, comprising the steps of:
(a) forming a dispersion comprising carbon particles, a metal precursor, an amino additive and a solvent;
(b) drying the dispersion of the forming step (a) to form a dried powder; and
(c) heating the dried power of the drying step (b) in an atmosphere comprising an inert gas to obtain the composite material.

10. The method of claim 9, wherein the carbon particles of the forming step (a) are prepared from a method comprising the steps of:
(a) treating a mixture comprising (i) an inorganic salt and (ii) a solution comprising a carbon source hydrothermally to form a solution of carbon particles; and
(b) collecting the carbon particles from the solution of the treating step (a).

11. The method of claim 9, wherein the drying step (b) comprises spray drying of the dispersion of the forming step (a).

12. The method of claim 9, wherein the drying step (b) comprises freeze drying of the dispersion of the forming step (a).

13. The method of claim 9, wherein the atmosphere of the heating step (c) further comprises hydrogen, or wherein the atmosphere of the heating step (c) is forming gas.

14. (canceled)

15. The method of claim 9, further comprising a step (d) of modifying the composite material after the heating step (c).

16. A composite material comprising a carbon support and a plurality of metal particles, wherein the metal particles are disposed within the carbon support.

17. The composite material of claim 16, wherein the composite material is in the form of a cluster or particles.

18. The composite material of claim 16, wherein the metal particles have a particle size of less than 100 nm.

19. The composite material of claim 16, further comprising an inorganic salt.

20. A composite material prepared by a method comprising the steps of:
(a) forming a dispersion comprising carbon particles, a metal precursor, an amino additive and a solvent;
(b) drying the dispersion of the forming step (a) to form a dried powder; and
(c) heating the dried powder of the drying step (b) in an atmosphere comprising an inert gas to obtain the composite material.

21. An article comprising the composite material of claim 16.
